(19) United States
(12) Patent Application Publication
(10) Pub. No.: US 2026/0115600 A1
(43) Pub. Date: Apr. 30, 2026

(54) SALIENCY MAP GENERATING BASED ON A SYNTHETIC USER DATA PIPELINE

(71) Applicant: ATI TECHNOLOGIES ULC, Markham (CA)

(72) Inventors: Yosi Hatekar, Toronto (CA); Zhongzhen Luo, Markham (CA); William Lloyd Atkinson, Markham (CA)

(21) Appl. No.: 18/929,451

(22) Filed: Oct. 28, 2024

(51) Int. Cl. A63F 13/67; G06F 40/40; G06N 3/0464; G06V 10/25; G06V 10/46; G06V 10/762; G06V 10/77; G06V 10/82

(52) U.S. Cl. CPC A63F 13/67; G06F 40/40; G06N 3/0464; G06V 10/25; G06V 10/462; G06V 10/762; G06V 10/7715; G06V 10/82

(57) ABSTRACT

A processing system is configured to generate a saliency map for a frame by implementing a synthetic user data pipeline. This synthetic user data pipeline first includes a processing unit that uses multimodal large language models to generate user action data based on data representing the frame, the context of the frame, and different user types. Additionally, the synthetic user data pipeline includes a curation portion that include the processing unit using clustering machine-learning models to form user clusters that are used to train convolutional machine-learning models. Further, the synthetic user data pipeline includes a production portion during which the processing unit uses the trained convolutional machine-learning models to generate a saliency map from the user action data, frame, and frame context data.

### BACKGROUND

To generate a saliency map indicating regions of interest in a frame, processing systems use data collected from large groups of users. To collect this data, these processing systems include various sensors that track different measurements of users looking at the frame such as the gaze of the users. Using the tracked measurements, the processing systems then determine regions of interest within the frame and generate a corresponding saliency map from the determined regions of interest. However, generating a saliency map using measured user data requires multiple users to be measured, increasing the size of the processing system, cost of the processing system, and time needed to determine a saliency map. Additionally, generating a saliency map using measured user data requires new measurements to be tracked for each saliency map that is to be generated, vastly increasing the time and effort needed to generate saliency maps for a set of frames.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system configured for saliency map generation based on a synthetic user data pipeline, in accordance with some embodiments.

FIG. 2 is a block diagram of a collection portion of a synthetic user data pipeline for saliency map generation, in accordance with some embodiments.

FIG. 3 is a block diagram of a curation portion of a synthetic user data pipeline for saliency map generation, in accordance with some embodiments.

FIG. 4 is a block diagram of a production portion of a synthetic user data pipeline for saliency map generation, in accordance with some embodiments.

FIG. 5 is a flow diagram of an example method for generating a saliency map based on a synthetic user data pipeline, in accordance with some embodiments.

### DETAILED DESCRIPTION

Systems and techniques disclosed herein are directed toward a processing system configured to generate a saliency map for a frame based on a synthetic user data pipeline. That is, systems and techniques disclosed herein are directed toward generating a saliency map for a frame using synthetic user data generated based on a synthetic user data pipeline. A frame for which a saliency map is generated includes, for example, data representing at least a portion of a captured image, a series of captured images (e.g., series of consecutive images), captured video, rendered video, or any combination thereof. As an example, a frame from which a saliency map is generated includes a rendered frame representing at least a portion of a video game environment of a certain video game. As another example, a frame for which a saliency map is generated includes a captured image or video of a route on which an autonomous vehicle, drone, or the like may travel. Additionally, a resulting saliency map for a frame includes data indicating one or more regions of interest within a corresponding frame. For example, a saliency map includes one or more highlighted regions, brightened regions, bounding boxes, or the like indicating one or more regions of interest within a frame.

To generate a saliency map for a frame, the processing system includes a processing unit (e.g., accelerator unit (AU)) configured to implement a synthetic user data pipeline that includes at least a collection portion, curation portion, production portion, or any combination thereof. The collection portion of the synthetic user data pipeline includes the processing unit generating user action data based on a frame and user type data. Such user type data, for example, represents one or more user types associated with the content of the frame for which a saliency map is to be generated. For example, based on the frame representing at least a portion of a video game environment, user type data indicates one or more user types that each indicate one or more user playstyles (e.g., careful, reckless, diligent, careless, fast, slow) for the video game represented by the frame, player classes (e.g., thief, warrior, cleric, rogue, healer, tank, support, damage-dealer) within the video game represented by the frame, user experience (e.g., beginner, intermediate, advanced, expert) with the video game represented by the frame, or any combination thereof. As another example, based on the frame representing a route for an autonomous vehicle (e.g., truck, car, plane, ship, drone, aircraft, submersible), user type data includes one or more user types each indicating one or more driving styles (e.g., safe, passive, aggressive, reckless, fast, slow), vehicle types (e.g., car, truck, sports utility vehicle, plane, ship, drone, aircraft, submersible), payloads (e.g., passengers, packages, freight), or any combination thereof. The user action data generated during the collection portion of the synthetic user data pipeline includes, for each user type indicated in the user type data, one or more actions taken in response to the content represented by the frame and a score that indicates a progress within the context represented by the frame (e.g., progress in a video game, progress along a route). For example, based on the frame representing at least a portion of a video game environment, the resulting user action data includes actions taken by different user types in the corresponding video game and corresponding scores. As another example, based on the frame representing a route for an autonomous vehicle, the resulting user action data includes actions taken by different user types along the route and corresponding scores.

To generate the user action data during the collection phase, the processing unit implements one or more multimodal large language models (MLLMs) configured to receive one or more data types as inputs such as visual data, textual data, audio data, sensor data, and the like. To implement an MLLM, a processing unit first trains the MLLM based on frame context data associated with the content represented by the frame for which a saliency map is to be generated. As user herein, “training” a machine-learning model includes full training of the machine-learning model, fine-tuning a machine-learning model (e.g., a pre-trained machine-learning model), or both. Such frame context data, for example, includes data indicating contexts that arise in the content represented by the frame and associated user actions (e.g., actions a user takes in response to a corresponding context). As an example, based on a frame representing a video game environment, frame context data indicates contexts for the video game represented by the frame such as certain scores, playing times, match times, health levels (e.g., hit points, hearts), ammo levels, equipment, companions, players, kills, deaths, game levels, dialogue choices, environments, and the like within the video game and corresponding user actions taken in response to these contexts. As another example, based on a frame representing a route for an autonomous vehicle, frame context data indicates contexts for the route represented by the frame such as weather conditions, traffic, signage, vehicle condition, number of lanes, speed limits, tolls, and the like and corresponding user actions taken in response to these contexts. After the processing unit trains the MLLM with the frame context data, the trained MLLM is configured to receive the frame and user type data representing one or more certain user types as inputs and generate, as an output, user action data for each user type. The processing unit then provides the frame and user type data representing one or more certain user types as inputs to the trained MLLM such that the trained MLLM generates user action data indicating corresponding user actions for each of the one or more certain user types.

After user action data is generated during the collection portion of the synthetic user data pipeline, the processing unit is configured to implement a curation portion of the synthetic user data pipeline. During this curation portion, the processing unit is configured to generate user type clusters based on the user action data. For example, during the curation portion, the processing unit first builds context trajectory data based on the generated user action data. This context trajectory data, for example, includes a data structure (e.g., table) that includes data indicating one or more certain player types (e.g., as indicated by the user type data), corresponding actions generated during the collection phase (e.g., as indicated by the generated user action data), and a corresponding score (e.g., as indicated by the generated user action data). The processing unit then implements one or more unsupervised clustering machine-learning models configured to cluster data within the context trajectory data to generate user type clusters. These user type clusters, for example, include groups of actions each associated with a corresponding user type. After the processing unit has generated the user type clusters, the processing unit implements the production portion of the synthetic user data pipeline. This production portion includes the processing unit training one or more machine-learning models using the user type clusters such that the trained machine-learning models are configured to receive at least the user action data, frame, and frame context data as inputs and output one or more attention maps as an output. For example, the processing unit trains one or more convolutional neural networks using the user type clusters to produce a trained convolutional neural network configured to extract one or more attention maps from the user action data generated during the collection portion, the frame, and frame context data. These attention maps, for example, include data indicating regions of interest within the frame. That is, data indicating regions within the frame which are likely to draw the attention of one or more users.

The processing unit then performs one or more postprocessing operations, refinement operations, or both using the attention maps to generate a saliency map for the frame. For example, the processing unit maps one or more attention maps to pixels in the frame, performs one or more pixel enhancement techniques (e.g., gamma correction, tone mapping, histogram equalization, contrast enhancement, noise masking), or both to produce a saliency map for the frame. In this way, the processing system is configured to generate a saliency map for a frame using user data synthetically generated by the processing system rather than manually collected user data. Because the processing system generates the saliency map using synthetic user data rather than manually collected user data, the time, expense, and infrastructure needed to produce a saliency map for a frame is reduced, allowing the processing system to more quickly and more cheaply generate saliency maps when compared to manually collected data techniques. Further, because the processing system generates the saliency maps using synthetic user data rather than only data determined from a frame, the accuracy of the saliency map is improved when compared to techniques that only use frame data to determine a saliency map. Additionally, as synthetic user data is used instead of collected user data, user privacy of the system is improved as there is no collected user data shared.

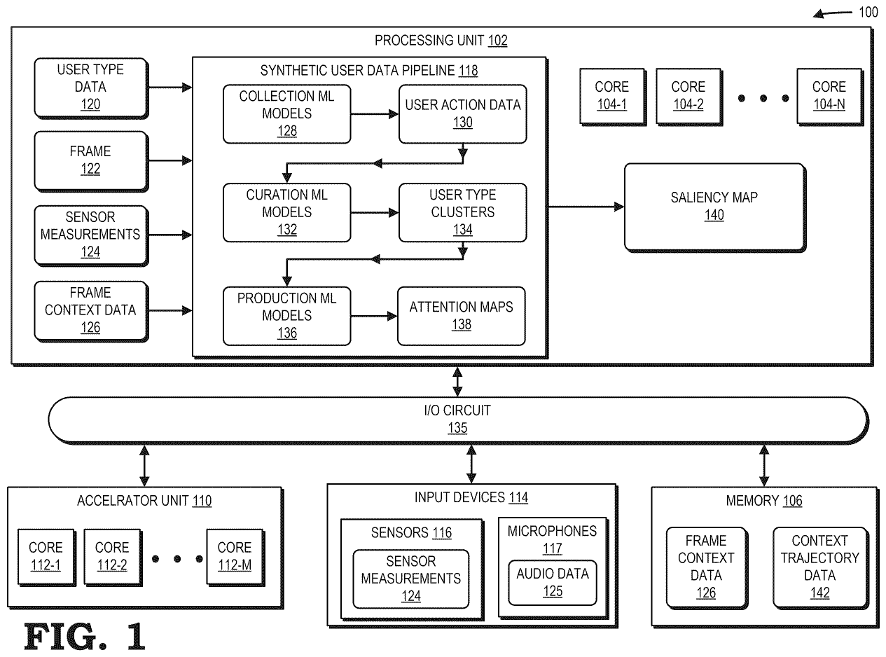

Referring now to FIG. 1, a processing system 100 configured for saliency map generation based on a synthetic user data pipeline is presented, in accordance with some embodiments. For example, the processing system 100 is configured to generate a saliency map 140 for a frame 122 using data generated based on a synthetic user data pipeline 118. Within processing system 100, the frame 122 for which a saliency map 140 is to be generated includes data representing one or more rendered images, series of rendered images (e.g., series of consecutive rendered images), rendered video, captured images, series of captured images (e.g., series of consecutive captured images), captured video, or any combination thereof. As an example, in some embodiments, frame 122 includes data representing at least a portion of a rendered video game environment for a certain video game application. As another example, in some embodiments, frame 122 includes data representing a captured image of a route (e.g., road, highway, waterway, path, sidewalk, building) on which an autonomous vehicle is to travel. Additionally, within processing system 100, a resulting saliency map 140 includes data indicating one or more regions of interest within a corresponding frame 122. For example, a saliency map 140 includes one or more highlighted regions, brightened regions, bounding boxes, or the like indicating one or more regions of interest within a frame 122. Such regions of interest within a frame 122, for example, each include groups of one or more pixels within a frame 122 that have historically or are predicted to draw attention to one or more users. As an example, a region of interest within a frame 122 representing at least a portion of a video game environment represents one or more groups of pixels that have historically or are predicted to draw attention to one or more players. As another example, a region of interest within a frame 122 representing a route for an autonomous vehicle represents one or more groups of pixels that have historically or are predicted to draw attention to one or more autonomous vehicles (e.g., visual sensors of one or more autonomous vehicles).

To generate a saliency map 140 for a frame 122, processing system 100 is configured to generate synthetic user data based on a synthetic user data pipeline 118 and extract one or more attention maps 138 from the synthetic user data. For example, in embodiments, processing system 100 includes processing unit 102 configured to generate one or more saliency maps 140 for a frame 122 by implementing a synthetic user data pipeline 118. To generate these saliency maps 140, processing unit 102 includes one or more processor cores 104 configured to execute instructions concurrently or in parallel. Though the example embodiment presented in FIG. 1 shows processing unit 102 as including three processing cores (104-1, 104-2, 104-N) representing an N integer number (where N>0) of processor cores, in other embodiments, processing unit 102 includes any integer number of processor cores 104. According to some embodiments, processing unit 102 is implemented as a CPU having any number of processor cores 104 each configured to concurrently execute two or more threads. According to other embodiments, processing unit 102 is implemented as an AU including one or more processor cores 104 operating as one or more compute units (e.g., groups of single instruction, multiple data (SIMD) units, vector registers, scalar registers, arithmetic logic units (ALUs)) that perform the same operation on different data sets. Such an AU, for example, includes one or more processors, coprocessors, graphics processing units (GPUs), general-purpose GPUs (GPGPUs), non-scalar processors, highly parallel processors, artificial intelligence (AI) processors, neural processing units (NPUs), inference engines, machine-learning processors, other multithreaded processing units, scalar processors, serial processors, programmable logic devices (e.g., field-programmable gate arrays (FPGAs)), or any combination thereof. In embodiments, synthetic user data pipeline 118 includes at least a collection portion, curation portion, production portion, or any combination thereof. During a collection portion of the synthetic user data pipeline 118, processing unit 102 is configured to generate user action data 130 based on a frame 122 and user type data 120. This user type data 120, for example, represents one or more user types associated with the content of the frame 122 (e.g., the content represented by the frame 122). For example, in embodiments, user type data 120 indicates a corresponding label for each of a number of user types and a corresponding description for each of a number of user types. These user types, for example, are based on the content of the frame 122.

As an example, according to some embodiments, based on a frame 122 representing at least a portion of a video game environment, user type data 120 indicates corresponding labels and descriptions for one or more user types each including one or more user playstyles (e.g., careful, reckless, diligent, careless, fast, slow) for the video game represented by the frame; player classes (e.g., thief, warrior, cleric, rogue, healer, tank, support, damage-dealer) within the video game represented by the frame; user experience (e.g., beginner, intermediate, advanced, expert) with the video game represented by the frame, or any combination thereof. For example, based on a frame 122 representing at least a portion of a video game environment, user type data 120 includes a user type having a label indicating a “safe runner” and a corresponding description indicating that a safe runner “completes the dungeon as quickly as possible while avoiding enemies.” As another example, user type data 120 includes a user type having a label indicating a “monster killer” and a corresponding description indicating that a monster killer “kills as many enemies as possible.” As yet another example, user type data 120 includes a user type having a label indicating an “experienced treasure hunter” and a corresponding description indicating that an experienced treasure hunter “only collects treasure of a certain rarity.” Further, in some embodiments, based on a frame 122 representing a route for an autonomous vehicle (e.g., truck, car, plane, ship, drone, aircraft, submersible), user type data 120 includes user types each indicating corresponding labels and descriptions for one or more driving styles (e.g., safe, passive, aggressive, reckless, fast, slow, economic), vehicle types (e.g., car, truck, sports utility vehicle, drone, plane, ship, aircraft, submersible), payloads (e.g., passengers, packages, freight), or any combination thereof. As an example, based on a frame 122 representing a route for an autonomous vehicle, user type data 120 includes a user type having a label indicating “safe passenger vehicle” and a corresponding description indicating that the safe passenger vehicle “maintains a route and speed that minimizes collisions with other vehicles.” As another example, user type data 120 includes a user type having a label indicating “fast delivery vehicle” and a corresponding description indicating that the fast delivery vehicle “follows a route that minimizes the time between deliveries.” As yet another example, user type data 120 includes a user type having a label indicating “economic driver” and a corresponding description indicating that the economic driver “follows a route and speed that maximizes fuel economy or battery charge.”

Additionally, during the collection portion of the synthetic user data pipeline 118, the generated user action data 130 indicates one or more actions taken by one or more user types (e.g., as indicated in the user type data 120) and corresponding scores for the actions. The user actions indicated in user action data 130, for example, each represent an action taken by a certain user type based on the content of a corresponding frame 122. Further, the scores indicated by user action data 130 each indicate a progress of the context associated with the content of a corresponding frame 122. For example, based on a frame 122 representing at least a portion of a video game environment, resulting user action data 130 data includes user actions taken within the video game environment by different user types indicated in the user type data 120 and corresponding scores each indicate progress within the video game associated with the video game environment such as direct scores (e.g., sports scores, player scores, total experience), indirect scores (e.g., number of steps needed to craft a corresponding item, experience needed for a next level), or both. As another example, based on the frame 122 representing a route for an autonomous vehicle, resulting user action data 130 includes user actions taken by an autonomous vehicle within the represented portion of the route according to the different user types indicated in the user type data 120 and corresponding scores each indicating a progress along the route such as direct scores (e.g., total distance travel), indirect scores (e.g., distance to destination, number of turns before destination), or both.

To generate user action data 130 from a frame 122 and user type data 120, processing unit 102 is configured to implement one or more collection machine-learning models 128 configured to receive one or more types of data (e.g., video data, textual data, audio data, sensor data) as inputs and generate user action data 130 as an output. For example, in embodiments a collection machine-learning model 128 is configured to receive user type data 120 (e.g., textual data), frame 122 (e.g., visual data), data collected by one or more input devices 114 (e.g., audio data 125, sensor measurements 124), or any combination thereof as inputs and generate user action data 130 as an output. In embodiments, input devices 114 include one or more devices configured to record one or more types of data associated with a user. For example, according to some embodiments, input devices 114 include one or more sensors 116 configured to produce one or more sensor measurements 124 taken by one or sensors 116 while a user is playing a game associated with a frame 122, while a user is traveling on a route associated with a frame 122, or both. These sensors 116 include, but are not limited to, one or more accelerators, infrared sensors, time of flight sensors, light detection and ranging sensors, gyroscopes, radar sensors, sonar sensors, magnetometers, Hall effect sensors, heart-rate sensors, pulse oximeters, and the like. Further, such sensor measurements 124 include, but are not limited to, data indicating an acceleration of sensor 116 or user, distance from a sensor 116 or user, angle of a sensor or user, rotation count, user vitals (e.g., heart-rate, stress rate, blood oxygen), or any combination thereof. According to embodiments, one or more sensors 116 are implemented within a headset (e.g., virtual reality headset) operated by one or more users. Further, in some embodiments, input device 114 includes one or more microphones 117 configured to record audio of a user while a user is playing a game associated with a frame 122, while a user is traveling on a route associated with a frame 122, or both.

According to embodiments, the collection machine-learning models 128 implemented by processing unit 102 include, for example, one or more MLLMs (e.g., Llama 3, InternVL, GPT-4), mixture of expert machine-learning models, reinforcement learning models, or any combination thereof. To train a collection machine-learning model 128 such that the collection machine-learning model 128 is configured to receive a frame 122 and one or more user types as inputs and generate user action data 130 as an output, processing unit 102 trains the collection machine-learning model 128 based on frame context data 126. This frame context data 126, for example, indicates contexts that arise in the content represented by one or more frames 122 and corresponding user actions (e.g., predetermined actions a user takes in response to a corresponding context). As an example, based on a frame 122 representing at least a portion of an environment for a video game, frame context data 126 indicates contexts for the video game represented by the frame 122 such as certain scores, playing times, match times, health levels (e.g., hit points, hearts), ammo levels, equipment, companions, players, kills, deaths, game levels, dialogue choices, environments, and the like within the video game and corresponding user actions. As another example, based on a frame 122 representing a route for an autonomous vehicle, frame context data 126 indicates contexts for the represented route such as weather conditions, traffic, signage, vehicle condition, number of lanes, speed limits, tolls, and the like and corresponding user actions. According to embodiments, frame context data 126 is stored in memory 106 or another storage component implemented using a non-transitory computer-readable medium, for example, a dynamic random-access memory (DRAM). In some implementations, memory 106 is implemented using other types of memory including, for example, static random-access memory (SRAM), nonvolatile RAM, and the like. Further, memory 106, according to some implementations, includes an external memory to the processing units implemented in the processing system 100.

After training a collection machine-learning model 128 using frame context data 126, processing unit 102 provides user type data 120 indicating one or more user types and frame 122 to the trained collection machine-learning model 128 as inputs. Additionally, according to some embodiments, processing unit 102 further provides one or more sensor measurements 124 associated with the frame 122, audio data 125 associated with the frame 122, or both as inputs to the trained collection machine-learning model 128. Based on the inputs (e.g., frame 122, user type data 120, sensor measurements 124, audio data 125) provided to the trained control machine-learning model 128, the trained collection machine-learning model 128 produces user action data 130 indicating one or more corresponding actions for each user type indicated in the user type data 120 provided as an input. For example, for each user type indicated in the user type data 120, processing unit 102 runs the trained collection machine-learning model 128 using one or more same inputs (e.g., frame 122, sensor measurements 124, audio data 125) to generate corresponding user action data 130 indicating one or more actions for the user type, one or more corresponding scores, or both. In some embodiments, to help train, fine tune, execute, or any combination thereof one or more trained collection machine-learning models 128, processing system 100 includes accelerator unit AU 110 configured to perform one or more operators (e.g., matrix multiplication operators, Sigmoid linear unit (SiLU) operators, if operators) for a trained collection machine-learning model 128. AU 110, for example, is configured to operate as one or more vector processors, coprocessors, GPUs, GPGPUs, non-scalar processors, highly parallel processors, AI processors, NPUs, inference engines, machine-learning processors, other multithreaded processing units, scalar processors, serial processors, programmable logic devices (e.g., FPGAs), or any combination thereof. In implementations, AU 110 performs one or more operators, instructions, or both for one or more machine-learning models (e.g., collection machine-learning models 128, curation machine-learning models 132, production machine-learning models 136). To perform operators, instructions, or for one or more machine-learning models, AU 110 implements a plurality of processor cores 112-1, 112-2, 112-M that execute instructions concurrently or in parallel. In some implementations, one or more of the processor cores 112 each operate as one or more compute units (e.g., groups of single instruction, multiple data (SIMD) units, vector registers, scalar registers, ALUs) that perform the same operation on different data sets. Though in the example implementation illustrated in FIG. 1, AU 110 includes three processor cores (112-1, 112-2, 112-M) representing an M integer number of cores (where M>0), the number of processor cores 112 implemented in AU 110 is a matter of design choice. As such, in other implementations, AU 110 can include any non-zero integer number of processor cores 112.

In some embodiments, to enable communication between processing unit 102 and one or more other components (e.g., AU 110, memory 106, input devices 114) of processing system 100, processing system 100 includes input/output (I/O) circuit 135. I/O circuit 135 includes, for example, one or more busses, switches (e.g., PCI switches), data fabrics, queues, buffers, or the like. As an example, in implementations, I/O circuit 135 is configured to connect input devices 114 to processing unit 102, memory 106, or both. As another example, I/O circuit 135 is configured to connect a command processor of AU 110 (now shown for clarity) to one or more processor cores 104 of processing unit 102, memory 106, or both.

According to embodiments, after generating user action data 130 using one more trained collection machine-learning models 128, processing unit 102 is configured to implement a curation portion of the synthetic user data pipeline 118. During the curation portion of the synthetic user data pipeline 118, processing unit 102 is configured to generate one or more user type clusters 134 based on user action data 130 generated during the collection portion of the synthetic user data pipeline 118. For example, during the curation portion, processing unit 102 first builds context trajectory data 142 based on the user action data 130 generated during the collection portion. This context trajectory data 142, for example, includes a data structure (e.g., table) that includes one or more entries (e.g., rows) each indicating a certain user type, user action or group of user actions indicated in user action data 130, a corresponding score for the user action or group of user actions indicated in user action data 130, and context data for the content of a frame 122. This context data for the content of the frame 122, for example, includes data describing the content of a frame 122 used to generate user action data 130 such as certain scores, playing times, match times, health levels, ammo levels, equipment, companions, players, kills, deaths, game levels, dialogue choices, environments, weather conditions, traffic, signage, vehicle condition, number of lanes, speed limits, tolls, and the like depending on the type of content (e.g., video game, autonomous vehicle route) of the frame 122. According to some embodiments, processing unit 102 is configured to build context trajectory data 142 based on the user action data 130 by rearranging user action data 130 to form one or more entries of context trajectory data 142, adding data indicated in user action data 130 to existing context trajectory data 142, or both.

After generating context trajectory data 142 from user action data 130, processing unit 102 is configured to sort context trajectory data 142 using one or more curation machine-learning models 132 to form one or more user type clusters 134. That is, processing unit 102 implements one or more curation machine-learning models 132 configured to cluster the data indicated in context trajectory data 142 to form user type clusters 134. Such user type clusters 134, for example, each include data indicating groups of user actions associated with a corresponding user type indicated in the context trajectory data 142. In embodiments, the curation machine-learning models 132 implemented by processing unit 102 include one or more unsupervised clustering machine-learning models such as fuzzy clustering models, k-means clustering models, deep AutoEncoder clustering models, or the like. According to some embodiments, processing unit 102 is configured to determine the group of user actions in a user type cluster 134 most representative of the user type of the user type cluster 134. For example, processing unit 102 implements a k-top selection model to determine the context trajectory data 142 most closely associated with each user type to form user type clusters 134. Processing unit 102 then modifies the user type cluster 134 such that the user type cluster 134 indicates the user actions indicated in the context trajectory data 142 most representative of the user type of the user type cluster 134. In some embodiments, AU 110 is configured to perform one or more operators, instructions, or both for one or more curation machine-learning models 132. After processing unit 102 generates user type clusters 134, processing unit 102 implements a production portion of synthetic user data pipeline 118. During the production portion, processing unit 102 is configured to generate one or more attention maps 138 based on the user action data 130 generated during the collection portion of the synthetic user data pipeline 118. Such attention maps 138, for example, include data indicating one or more regions of interest in the frame 122 (e.g., one or more regions within the frame 122 which are likely to draw the attention of one or more corresponding users).

To generate one or more attention maps 138, processing unit 102 is configured to first train one or more production machine-learning models 136 using the user type clusters 134 generated during the curation portion. As an example, using user type clusters 134 indicating the user actions indicated in the context trajectory data 142 most representative of the user type of the user type cluster 134, processing unit 102 trains one or more production machine-learning models 136. Such production machine-learning models 136, for example, include one or more convolutional neural networks configured to extract one or more features (e.g., attention maps 138) from user action data 130 generated during the collection portion of the synthetic user data pipeline 118. For example, one or more production machine-learning models 136 includes a deep multi-task regression convolutional neural network, class activation mapping neural network, residual neural network, or any combination thereof. After training a production machine-learning model 136 using the user type clusters 134, processing unit 102 provides the user action data 130 generated during the collection portion of the synthetic user data pipeline 118, the frame 122, frame context data 126, sensor measurements 124, or any combination thereof to the production machine-learning model 136 as inputs. One or more layers of the production machine-learning model 136 then perform one or more convolution operations based on the user action data 130, frame 122, frame context data 126, sensor measurements 124, or any combination thereof to extract one or more attention maps 138. According to some embodiments, AU 110 is configured to perform one or more operators for one or more production machine-learning models 136.

After generating one or more attention maps 138, processing unit 102 then performs one or more postprocessing operations, refinement operations, or both using the attention maps 138 to generate a saliency map 140 for the frame 122 input during the collection portion of the synthetic user data pipeline 118. As an example, processing unit 102 maps one or more attention maps 138 to pixels in a corresponding frame 122, performs one or more pixel enhancement techniques (e.g., gamma correction, tone mapping, histogram equalization, contrast enhancement, noise masking), or both to produce a saliency map 140 for the frame 122 input during the collection portion of the synthetic user data pipeline 118. In this way, processing system 100 generates a saliency map 140 for a frame 122 using user data synthetically generated by processing system 100 rather than by using manually collected user data. Due to using synthetic user data generated by processing system 100 rather than manually collected user data, the time, expense, and infrastructure needed to produce a saliency map 140 for a frame 122 is reduced when compared to manually collected data techniques. Further, because processing system 100 generates saliency maps 140 using synthetic user data rather than only from data determined from different frames 122, the accuracy of a resulting saliency map 140 is improved when compared to techniques that only use frame data to determine a saliency map 140.

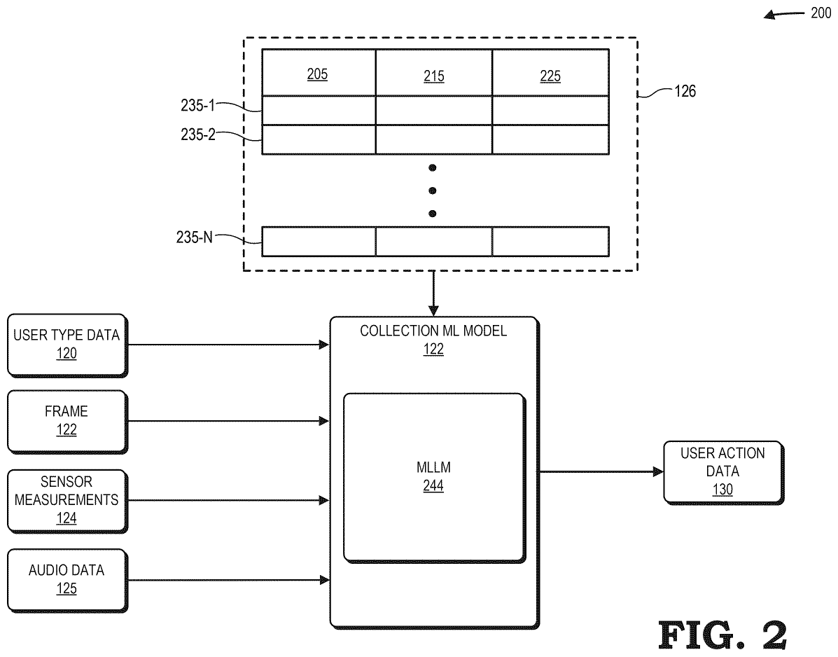

Referring now to FIG. 2, a collection portion 200 of a synthetic user data pipeline for saliency map generation is presented, in accordance with embodiments. In embodiments, collection portion 200 forms at least a portion of synthetic user data pipeline 118 and is implemented at least in part by processing unit 102, AU 110, or both. According to embodiments, collection portion 200 includes a collection machine-learning model 128 configured to receive one or more types of data (e.g., visual data, textual data, audio data, sensor data) as inputs and generate user action data 130 as an output. For example, collection machine-learning model 128 includes one or more MLLMs 244 configured to receive user type data 120 (e.g., textual data) and a frame 122 as inputs and generate user action data 130 as an output. These MLLMs 244, for example, include one or more modality encoders (visual encoders, audio encoders, speech encoders, sensor measurement encoders) each configured to encode a corresponding type of data, word embedding layers, attention layers, mixture of expert layers, or any combination thereof together configured to generate user type data 120 based on at least user type data 120 (e.g., textual data) and a frame 122 as inputs. As an example, such MLLMs 244 include Llama 3, InternVL, GPT-4, or the like. Additionally, according to some embodiments, in addition to user type data 120 (e.g., textual data) and a frame 122 (e.g., visual data), collection machine-learning model 128 includes one or more MLLMs configured to generate user action data 130 further based upon sensor measurements 124, audio data 125, or both.

To train MLLMs 244, processing unit 102 is configured to use frame context data 126 which indicates one or more contexts that arise in the content represented by one or more frames 122 to be input to one or more MLLMs 244 of collection machine-learning model 128. For example, frame context data 126 includes a data structure (e.g., table) having one or more entries 235 (e.g., lines). Though the example embodiment presented in FIG. 2 shows frame context data 126 as including three entries (235-1, 235-2, 235-N) representing an N integer number of entries (where N>0), in other embodiments, frame context data 126 can include any non-zero integer number of entries 235. Each entry 235, for example, indicates a content 205 of a frame, context 215, and user actions 225. Such content 205, for example, includes data describing the content of one or frames 122 to be input to the collection machine-learning model 128. For example, content 205 includes data describing a certain video game represented by a frame 122, a certain route represented by a frame 122, a certain location represented by a frame 122, or any combination thereof. Further, the context 215 of an entry 235 includes data describing an environment, parameters, metrics, or any combination thereof of the associated content 205 (e.g., the content 205 of the same entry 235). For example, for an entry 235 having a content 205 describing a certain video game, a corresponding context 215 includes data describing certain scores, playing times, match times, health levels (e.g., hit points, hearts), ammo levels, equipment, companions, players, kills, deaths, game levels, dialogue choices, environments, and the like within the video game. As another example, for an entry 235 having a content 205 describing a certain route, a corresponding context 215 includes data describing weather conditions, traffic, signage, vehicle condition, number of lanes, speed limits, tolls, and the like of the route.

The user actions 225 of an entry 235 includes data indicating one or more user actions taken in response to the environment, parameters, metrics, or any combination thereof described by the context 215 of the same entry 235. For example, based on a context 215 of an entry 235 describing a certain score and match time for a video game, the user actions 225 of the same entry includes data describing one or more user actions taken in response to the described context 215 such a kick, pass, shoot, and the like. As another example, based on a context 215 of an entry 235 describing the weather and traffic for a route, the user actions 225 of the same entry includes data describing one or more user actions taken in response to the described context 215 such a reduce speed, maintain a predetermined follow distance, and the like.

After training one or more MLLMs 244 of the collection machine-learning model 128, processing unit 102 is configured to provide user type data 120 indicating a first user type and a frame 122 to the trained MLLMs 244. According to some embodiments, processing unit 102 further provides one or more sensor measurements 124, audio data 125, or both to the trained MLLMs 244. Based on at least the first user type indicated in the user type data 120 and the frame 122 and according to the frame context data 126 used to train the MLLMs 244, the trained MLLMs 244 output user action data 130 indicating one or more user actions taken by the first user type and a score representing a progress within the context represented by the content of the frame 122 (e.g., process within a video game or route represented by the frame 122) associated with the one or more user actions. Processing unit 102 then provides user type data 120 indicating a second user type and the same frame 122 to the trained MLLMs 244. Further, in some embodiments, the processing unit 102 also provides the same sensor measurements 124, audio data 125, or both to the trained MLLMs 244. Based on at least the second user type indicated in the user type data 120 and the frame 122 and according to the frame context data 126 used to train the MLLMs 244, the trained MLLMs 244 output user action data 130 indicating one or more user actions taken by the second user type and a score representing a progress within the context associated with the content of the frame 122. Processing unit 102 then continues providing inputs to the trained MLLMs 244 in this way until user action data 130 indicating one or more actions taken by a predetermined number of user types is generated.

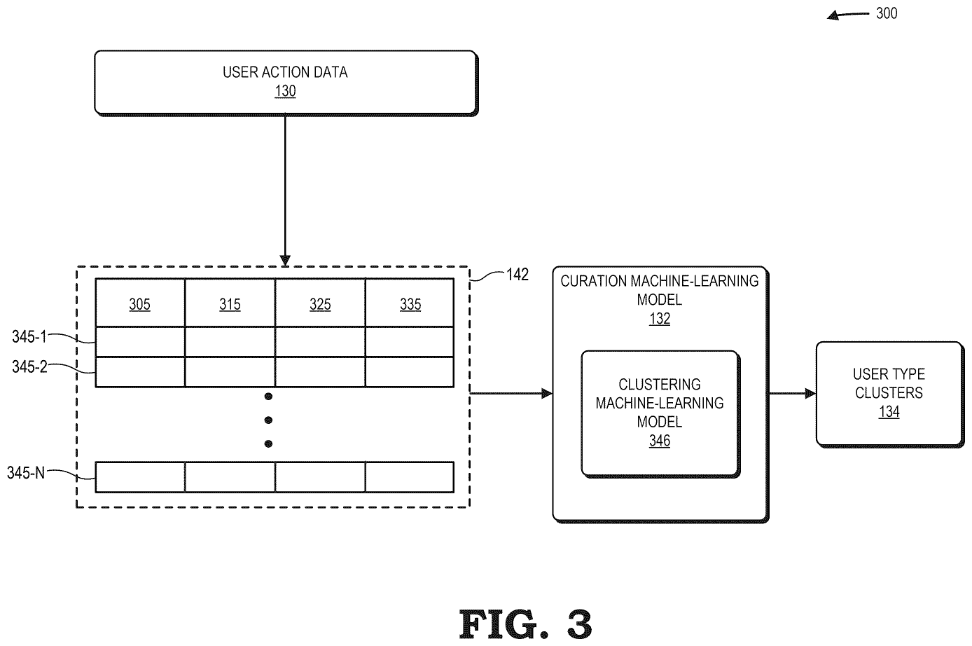

Referring now to FIG. 3, a curation portion 300 of a synthetic user data pipeline for saliency map generation is presented, in accordance with embodiments. In embodiments, curation portion 300 forms at least a portion of synthetic user data pipeline 118 and is implemented at least in part by processing unit 102, AU 110, or both. According to embodiments, during the curation portion 300, processing unit 102 is configured to generate context trajectory data 142 based on the user action data 130 generated, for example, during the collection portion 200. That is, based on user action data 130 indicating one or more user actions for one or more user types and corresponding scores for each of the one or more user actions, processing unit 102 generates context trajectory data 142. For example, based on user action data 130, processing unit 102 generates context trajectory data 142 that includes a data structure (e.g., a table) with one or more entries 345 (e.g., lines) each indicating a user type 305, frame context 315, user trajectory 325, and a score 335. Though the example embodiment presented in FIG. 3 shows context trajectory data 142 as including three entries (345-1, 345-2, 345-N) representing an N integer number of entries (where N>0), in other embodiments, context trajectory data 142 can include any number of entries 345.

The user type 305 indicated in an entry of context trajectory data 142, for example, includes data indicating a corresponding user type in the user action data 130. That is, a corresponding user type for which user action data 130 indicates one or more user actions. As an example, based on a frame 122 representing at least a portion of a video game environment being used to generate user action data 130 during collection portion 200, the user type 305 of an entry 345 includes data indicating a certain playstyle (e.g., careful, reckless, diligent, careless, fast, slow), player class (e.g., thief, warrior, cleric, rogue, healer, tank, support, damage-dealer), user experience (e.g., beginner, intermediate, advanced, expert), or any combination thereof for the video game. As another example, based on a frame 122 representing a route for an autonomous vehicle being used to generated user action data 130 during collection portion 200, the user type 305 of an entry includes data indicating a certain driving style (e.g., safe, passive, aggressive, reckless, fast, slow), vehicle type (e.g., car, truck, sports utility vehicle), payload (e.g., passengers, packages, freight), or any combination thereof. Further, the frame context 315 of an entry 345 includes data indicating the environment, one or more metrics, one or more parameters, or any combination thereof of the content in the frame 122 used to generate user action data 130. For example, based on such a frame 122 representing at least a portion of a video game environment, the frame context 315 of an entry 345 includes data indicating certain scores, playing times, match times, health levels (e.g., hit points, hearts), ammo levels, equipment, companions, players, kills, deaths, game levels, dialogue choices, environments, and the like represented by the content of the frame 122. As another example, based on a frame 122 representing a route for an autonomous vehicle, the frame context 315 of an entry 345 includes data indicating weather conditions, traffic, signage, vehicle condition, number of lanes, speed limits, tolls, and the like represented by the content of the frame 122.

In embodiments, the user trajectory 325 of an entry 345 includes data indicating a group or sequence of one or more user actions taken by the user type 305 indicated in the entry 345 in response to the frame context 315 of the entry 345 as indicated by the user action data 130. Further, the score 335 of an entry 345 includes data representing a progress within the frame context corresponding to the user actions indicated in the user trajectory 325 of the entry 345. For example, based on a frame 122 representing at least a portion of a video game environment of a video game, a score 335 includes data representing progress within the video game such as a direct score (e.g., sports score, player score, total experience), indirect score (e.g., steps needed to craft an item, experience needed to level, distance left to a destination), or both. As another example, based on a frame 122 representing a route for an autonomous vehicle, a score 335 includes data representing progress along the route such as a direct score (e.g., total distance travels, time traveled), indirect score (e.g., distance to a destination, number of turns until a destination), or both. According to some embodiments, processing unit 102 is configured to build context trajectory data 142 by generating one or more entries 345 based on user action data 130 generated during the collection portion 200, modifying context trajectory data 142 stored in memory 106, or both. As an example, in embodiments, processing unit 102 is configured to generate one or more entries 345 based on user action data 130 and then add these entries to context trajectory data 142 stored in memory 106. After generating context trajectory data 142, processing unit 102 then sorts the context trajectory data 142 to form one or more user type clusters 134. Such user type clusters 134, for example, include groups of user actions (e.g., as indicated in user trajectories 325) each associated with a corresponding user type 305. To form these user type clusters 134, curation portion 300 includes a curation machine-learning model 132 configured to sort context trajectory data 142. For example, curation machine-learning model 132 includes one or more clustering models 346 such as fuzzy clustering models, K-means clustering models, deep AutoEncoder clustering models, and the like, configured to sort context trajectory data 142 to form user type clusters 134. As an example, based on the user types 305, frame contexts 315, and scores 335 of each entry 345, one or more clustering models 346 are configured to sort the user actions indicated in the user trajectories 325 of each entry 345 to form user type clusters 134.

According to some embodiments, curation portion 300 further includes a curation machine-learning model 132 determining the user action or group of user action indicated in a user type cluster 134 that most represent the user type 305 indicated in the user type cluster 134. That is, a curation machine-learning model 132 determining the user action or group of user action indicated in a user type cluster 134 mostly closely associated with the user type 305 indicated in the user type cluster 134. As an example, curation machine-learning model 132 includes a top-K selection model configured to determine the user action or group of user actions of each user type cluster 134 that most represent the user type 305 of the corresponding user type cluster 134. In some embodiments, curation portion 300 includes processing unit 102 modifying one or more user type clusters 134 such that these user type clusters 134 each indicate the user action or groups of user actions that most represent the user type 305 of the user type cluster 134.

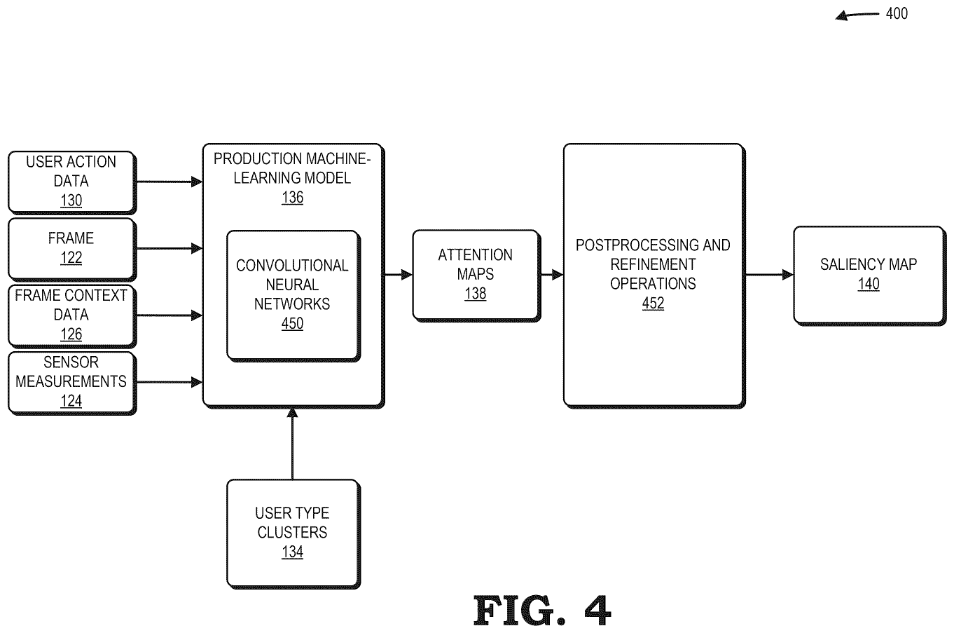

Referring now to FIG. 4, a production portion 400 of a synthetic user data pipeline for saliency map generation is presented, in accordance with embodiments. In embodiments, production portion 400 forms at least a portion of synthetic user data pipeline 118 and is implemented at least in part by processing unit 102, AU 110, or both. According to embodiments, production portion 400 includes processing unit 102 extracting one or more attention maps 138 from user action data 130 generated during the collection portion 200, frame 122, and frame context data 126. In some embodiments, in production portion 400, processing unit 102 is configured to further extract one or more attentions maps 138 using sensor measurements 124 such that processing unit 102 extracts the attention maps 138 based on user action data 130, frame 122, frame context data 126, and sensor measurements 124. For example, to extract one or more attention maps 138, processing unit 102 is configured to implement a production machine-learning model 136 that includes one or more convolutional neural networks 450. These convolutional neural networks 450, for example, are configured to receive data as an input and extract one or more predetermined features from the input data by performing convolution operations at different scales (e.g., resolutions). For example, a convolutional neural network 450 includes one or more convolutional layers each configured to receive user action data 130, frame 122, frame context data 126, sensor measurements 124, or any combination thereof at a first scale as an input, perform one or more convolution operators using the user action data 130 at the first scale, and output data (e.g., feature maps) representing the user action data 130 at a second scale, different from (e.g., smaller than) the first scale. Further, in embodiments, the convolutional neural network 450 includes one or more class activation layers configured to receive data from a convolutional layer as an input and map the input data to one or more values so as to generate an attention map 138. This resulting attention map 138, for example, includes data indicating one or more regions of interest (e.g., groups of pixels) within a frame 122 used to generate user action data 130. According to some embodiments, one or more convolutional neural networks 450 include deep multi-task regression convolutional neural networks with class activation mapping, residual neural networks, or both.

In embodiments, processing unit 102 is configured to train the convolutional neural networks 450 using the user type clusters 134 generated during the curation portion 300 of the synthetic user data pipeline 118. After training the convolutional neural networks 450, processing unit 102 then provides the user action data 130 generated during the collection portion 200, the frame 122, frame context data 126, sensor measurements 124, or any combination thereof to the trained convolutional neural networks 450 as inputs. Based on the user action data 130, the frame 122, frame context data 126, sensor measurements 124, or any combination thereof and based on user type clusters 134 used to train the trained convolutional neural networks 450, the trained convolutional neural networks 450 extract one or more attention maps 138 each indicating one or more regions of interest within the frame 122 used to generate user action data 130. Processing unit 102 then performs one or more postprocessing and refinement operations 452 using the generated attention maps 138. Such postprocessing and refinement operations 452 include, for example, processing unit 102 mapping the regions of interest indicated in one or more attention maps 138 to pixels in a corresponding frame 122, performing one or more pixel enhancement techniques (e.g., gamma correction, tone mapping, histogram equalization, contrast enhancement, noise masking) on an attention map 138, or both to produce a saliency map 140.

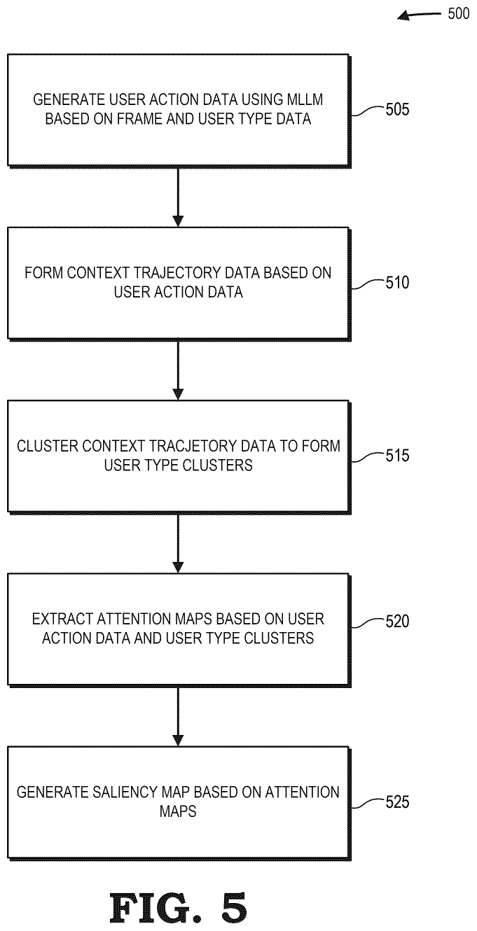

Referring now to FIG. 5, an example method 500 for generating a saliency map using a synthetic user data pipeline, in accordance with some embodiments. In embodiments, at least a portion of example method 500 is implemented by processing unit 102, AU 110, or both. At block 505 of example method 500, processing unit 102 is configured to implement a collection portion 200 of synthetic user data pipeline 118. During this collection portion 200, processing unit 102 is configured to first train one or more MLLMs 244 using corresponding frame context data 126. This frame context data 126, for example, indicates contexts that arise in the content of a frame 122 for which a saliency map 140 is to be generated. After training the MLLMs 244 using the frame context data 126, processing unit 102 provides at least user type data 120 and a frame 122 to the trained MLLMs 244 as inputs. This user type data 120, for example, includes data describing one or more user types associated with the content of the frame 122. Further, according to some embodiments, processing unit 102 is configured to provide one or more sensor measurements 124, audio data 125, or both as inputs to the trained MLLMs 244 in addition to the user type data 120 and frame 122. Based on at least the user type data 120 and frame 122 and according to the frame context data 126 used to train the trained MLLMs 244, the trained MLLMs 244 output user action data 130 representing one or more actions taken by corresponding user types in response to the content of the frame 122 and corresponding scores for the actions.

After generating the user action data 130, at block 510, processing unit 102 implements a curation portion 300 of the synthetic user data pipeline 118. During this curation portion 300, processing unit 102 is configured to generate context trajectory data 142 based on the user action data 130. For example, processing unit 102 generates one or more entries 345 each including a user type 305, frame context 315, user trajectory 325, and a score 335 based on the user action data 130. Processing unit 102, in some embodiments, then adds these generated entries 345 to context trajectory data 142 stored in memory 106. At block 515, processing unit 102 is configured to sort the context trajectory data 142 to form one or more user type clusters 134 each indicating groups or sequences of actions each associated with respective user types. As an example, processing unit 102 is configured to implement one or more clustering models 346 configured to receive the context trajectory data 142 as an input and generate one or more user type clusters 134 as an output. After generating the user type clusters 134, at block 520, processing unit 102 is configured to implement a production portion 400 of the synthetic user data pipeline 118 during which processing unit 102 generates one or more attention maps 138 from the user action data 130, frame 122, frame context data 126, or any combination thereof. According to some embodiments, processing unit 102 is configured to further generate one or more attentions maps 138 using sensor measurements 124 such that processing unit 102 generates the attention maps 138 based on user action data 130, frame 122, frame context data 126, and sensor measurements 124. For example, processing unit 102 first trains one or more convolutional neural networks 450 using the user type clusters 134 to produce one or more trained convolutional neural networks 450 configured to receive user action data 130, frame 122, frame context data 126, sensor measurements 124, or any combination thereof as inputs and generate one or more attention maps 138 as an output.

Still referring to block 520, processing unit 102 provides the user action data 130, frame 122, frame context data 126, or any combination thereof to the trained convolutional neural networks 450 as inputs. Based on the user action data 130, frame 122, frame context data 126, sensor measurements 124, or any combination thereof and according to the user type clusters 134 used to train the convolutional neural networks 450, the trained convolutional neural networks 450 generate one or more attention maps 138 each indicating one or more regions of interest within the frame 122 used to generate the user action data 130. At block 525, processing unit 102 is configured to generate a saliency map 140 from one or more of the attention maps 138. For example, processing unit 102 performs one or more postprocessing and refinement operations 452 using one or more attention maps 138 to generate a corresponding saliency map 140 for the frame 122 used to generate the attention maps 138. These postprocessing and refinement operations 452 include, for example, mapping the regions of interest indicated in one or more attention maps 138 to pixels in a corresponding frame 122, performing one or more pixel enhancement techniques (e.g., gamma correction, tone mapping, histogram equalization, contrast enhancement, noise masking) on an attention map 138, or both to produce a saliency map 140.

In some embodiments, the apparatus and techniques described above are implemented in a system including one or more integrated circuit (IC) devices (also referred to as integrated circuit packages or microchips), such as the processing unit 102 described above with reference to FIGS. 1-5. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer-readable storage medium may include any non-transitory storage medium, or combination of non-transitory storage media, accessible by a computer system during use to provide instructions and/or data to the computer system. Such storage media can include but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may be implemented by one or more processors of a processing system executing software. The software includes one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A processing system, comprising:
a processing unit including one or more processor cores, the one or more processor cores configured to:
based on a frame and a plurality of user types, generate user action data indicating one or more actions for each user type of the plurality of user types;
form one or more clusters based on the user action data; and
extract, by a convolutional neural network, a saliency map for the frame based on the user action data and the one or more clusters.

2. The processing system of claim 1, wherein the one or more processor cores are configured to:
train one or more multimodal large language models (MLLMs) using context data associated with the frame; and
generate, by the one or more MLLMs, the user action data based on the frame and the plurality of user types.

3. The processing system of claim 2, further comprising:
a sensor configured to generate one or more sensor measurements, wherein the one or more processor cores are configured to generate, by the one or more MLLMs, the user action data further based on the sensor measurements.

4. The processing system of claim 1, wherein the one or more processor cores are configured to:
generate context trajectory data based on the user action data; and
form, by one or more clustering machine-learning models, the clusters from the context trajectory data.

5. The processing system of claim 1, wherein the one or more processor cores are configured to:
train the convolutional neural network using the clusters;
extract, by the convolutional neural network, one or more attention maps from the user action data; and
generate the saliency map based on the one or more attention maps.

6. The processing system of claim 1, wherein each cluster of the one or more clusters includes a user action of the user action data associated with a corresponding user type of the plurality of user types.

7. The processing system of claim 1, further comprising:
an accelerator unit including one or more compute units configured to perform one or more operators for the convolutional neural network.

8. A method, comprising:
based on a frame and a plurality of user types, generating, by a multimodal large language model (MLLM), user action data indicating one or more actions for each user type of the plurality of user types;
forming, by a clustering machine-learning model, one or more clusters based on the user action data; and
extracting, by a convolutional neural network, a saliency map for the frame based on the user action data and the one or more clusters.

9. The method of claim 8, further comprising:
training the MLLM using context data associated with the frame such that the MLLM is configured to receive the frame and plurality of user types as inputs and generate the user action data as an output.

10. The method of claim 9, further comprising:
capturing, by a microphone, audio data, wherein the MLLM is trained such at the MLLM is configured to further receive the audio data in addition to the frame and plurality of user types as an input.

11. The method of claim 8, wherein forming the one or more clusters comprises:
generating context trajectory data based on the user action data; and
forming, by the clustering machine-learning model, the one or more clusters from the context trajectory data.

12. The method of claim 8, wherein extracting the saliency map comprises:
training the convolutional neural network using the clusters;
extracting, by the convolutional neural network, one or more attention maps from the user action data; and
generating the saliency map based on the one or more attention maps.

13. The method of claim 8, wherein each cluster of the one or more clusters includes a user action of the user action data associated with a corresponding user type of the plurality of user types.

14. The method of claim 8, further comprising:
performing one or more operators for the convolutional neural network by an accelerator unit.

15. A processing system, comprising:
a processing unit including one or more processor cores configured to:
train a multimodal large language model (MLLM) such that the MLLM is configured to receive a frame and a plurality of user types as inputs and generate user action data indicating one or more actions for each user type of the plurality of user types as an output;
form one or more clusters from the user action data;
train a convolutional neural network using the one or more clusters such that the convolutional neural network is configured to receive the user action data as an input and generate data indicating a region of interest in the frame as an output; and
generate a saliency map for the frame based on the data indicating the region of interest in the frame.

16. The processing system of claim 15, wherein the one or more processor cores are configured to:
train, using context data associated with the frame, the MLLM.

17. The processing system of claim 16, further comprising:
a sensor configured to generate one or more sensor measurements, wherein the one or more processor cores are configured to train the MLLM such that the MLLM is further configured to receive the one or more sensor measurements as an input.

18. The processing system of claim 15, wherein the one or more processor cores are configured to:
generate context trajectory data based on the user action data; and
form, by a clustering machine-learning model, the clusters from the context trajectory data.

19. The processing system of claim 15, wherein each cluster of the one or more clusters includes a user action of the user action data associated with a corresponding user type of the plurality of user types.

20. The processing system of claim 15, further comprising:
an accelerator unit including one or more compute units configured to perform one or more operators for the convolutional neural network.
